(19) United States
(12) Patent Application Publication
(10) Pub. No.: US 2025/0192361 A1
(43) Pub. Date: Jun. 12, 2025

(54) METHOD FOR PREPARING POLYPROPYLENE FOR SEPARATOR OF SECONDARY BATTERY HAVING EXCELLENT MECHANICAL AND THERMAL PROPERTIES

(71) Applicant: LOTTE CHEMICAL CORPORATION, Seoul (KR)

(72) Inventors: Sun Young Jung, Daejeon (KR); Chang Kyu Son, Daejeon (KR); Min Suk Jung, Daejeon (KR); Hee Won Cho, Daejeon (KR); Dong Jun Im, Daejeon (KR); Min Ji Kim, Daejeon, Republic of (KR); Kyung Hoon Kim, Daejeon (KR)

(73) Assignee: LOTTE CHEMICAL CORPORATION, Seoul (KR)

(21) Appl. No.: 18/711,444

(22) PCT Filed: Nov. 4, 2022
(86) PCT No.: PCT/KR2022/017250

§ 371 Date: Nov. 12, 2024

(30) Foreign Application Priority Data
Nov. 19, 2021 (KR) 10-2021-0160619

(51) Int. Cl. H01M 50/417; C08F 110/06

(52) U.S. Cl. CPC H01M 50/417; C08F 110/06

(57) ABSTRACT

In the preparation of polypropylene for a dry separator of a secondary battery, disclosed is a method for preparing polypropylene for a separator of a secondary battery, having improved flowability of a resin while maximizing mechanical and thermal properties, compared to typical materials. The present invention provides a method for preparing polypropylene for a separator of a secondary battery by subjecting, in the presence of a Ziegler-Natta catalyst, propylene monomers to a polymerization reaction, wherein the propylene monomer polymerization reaction includes a) obtaining a high molecular weight polypropylene having a weight average molecular weight of 450,000 to 650,000 g/mol in a first reactor, and b) obtaining a low molecular weight polypropylene having a weight average molecular weight of 150,000 to 300,000 g/mol in a second reactor, and the molar ratio of a co-catalyst and an electron donor added in step a) is adjusted to 2 to 25, thereby preparing the polypropylene for a separator of a secondary battery.

### TECHNICAL FIELD

The present invention relates to a method for preparing polypropylene, and more particularly, to a method for preparing polypropylene for a dry separator of a secondary battery.

This application claims the benefit of Korean Patent Application No. 10-2021-0160619, filed on Nov. 19, 2021, in the Korean Intellectual Property Office, the disclosure of which is incorporated herein in its entirety by reference.

### BACKGROUND ART

Polymer matrixes commonly used in the preparation of secondary battery separators include polyethylene or polypropylene, which is desirable in pore formation and is inexpensive.

Polypropylene has, as benefits, lower heat shrinkage and better mechanical properties than polyethylene. U.S. Pat. Nos. 5,385,777 and 5,480,745, and Korean Patent Laid-Open Publication No. 2003-0080007 disclose a method for preparing a polypropylene film for a separator of a secondary battery prepared through a dry method, which has excellent heat resistance and price competitiveness, but the typical methods have failed to provide satisfactory results in terms of mechanical and thermal properties.

Meanwhile, in Korean Patent No. 1711261, the applicant has proposed a polypropylene having excellent properties related to stereoregularity, crystallinity, melting temperature, and flexural modulus through the use of a catalyst prepared using a specific method, and a bimodal process, as a high heat resistance and high strength polypropylene for a separator of a secondary battery, but the polypropylene has limitations in maximizing mechanical and thermal properties.

### DISCLOSURE OF THE INVENTION

### Technical Problem

An aspect of the present invention provides, in the preparation of polypropylene for a dry separator of a secondary battery, a method for preparing polypropylene for a separator of a secondary battery, having improved flowability of a resin while maximizing mechanical and thermal properties, compared to typical materials.

### Technical Solution

According to an aspect of the present invention, there is provided a method for preparing polypropylene for a separator of a secondary battery by subjecting, in the presence of a Ziegler-Natta catalyst, propylene monomers to a polymerization reaction, wherein the propylene monomer polymerization reaction includes the steps of: a) obtaining a high molecular weight polypropylene having a weight average molecular weight of 450,000 to 650,000 g/mol in a first reactor; and b) obtaining a low molecular weight polypropylene having a weight average molecular weight of 150,000 to 300,000 g/mol in a second reactor, and the molar ratio of a co-catalyst and an electron donor added in step a) is adjusted to 2 to 25, thereby preparing the polypropylene for a separator of a secondary battery.

According to an embodiment of the present invention, the co-catalyst is at least one selected from the group consisting of trimethyl aluminum, triethyl aluminum, triisobutyl aluminum, and trioctyl aluminum, and the electron donor is at least one selected from the group consisting of cyclohexylmethyldimethoxysilane, dicyclopentyldimethoxysilane, diisopropyldimethoxysilane, vinyltriethoxysilane, triethylmethoxysilane, trimethylethoxysilane, dicyclopentyldiethoxysilane, ethyltrimethoxysilane, ethyltriethoxysilane, diphenyldiethoxysilane, phenylpropyldimethoxysilane, phenyltrimethoxysilane, tertiary butyltrimethoxysilane, cyclohexylethyldimethoxysilane, cyclohexylmethyldimethoxysilane, cyclopentyltriethoxysilane, diisobutyldiethoxysilane, isobutyltriethoxysilane, normalpropyltrimethoxysilane, isopropyltrimethoxysilane, cycloheptylmethyldiethoxysilane, and dicycloheptyldiethoxysilane.

According to an embodiment of the present invention, the polypropylene for a separator of a secondary battery has a weight average molecular weight of 300,000 to 500,000 g/mol, a molecular weight distribution (Mw/Mn) of 6 or greater, a meltdown temperature of 166° C. or greater, a xylene soluble of 3 wt % or less, a tensile strength of 1,300 kgf/cm² or greater, and a puncture strength of 220 gf or greater, measured according to methods below.

### [Method of Measuring Molecular Weight Properties]

Weight average molecular weight and molecular weight distribution (Mw/Mn) are measured using gel permeation chromatography (GPC) (Agilent) in accordance with ASTM D3536.

### [Method of Measuring Xylene Soluble]

A sample is dissolved in boiling xylene, and then an insoluble portion is crystallized from the solution, and a soluble portion is separated and measured in accordance with ASTM D5492.

### [Method of Measuring Meltdown Temperature]

The polypropylene for a separator is extruded using a twin-screw extruder at 220 to 250° C. through a T-die method to form a sheet, and then the sheet was sequentially stretched in MD and TD directions in a stretching machine to prepare a single-layer porous film having a thickness of 15 μm, and a lithium-ion secondary battery manufactured using the prepared porous film is heated in an oven at a rate of 2° C./min to measure resistance in real time so as to evaluate the temperature at the point of exceeding 10,000Ω as a shutdown temperature, and the temperature at the point of rapidly decreasing resistance after the above shutdown temperature as a meltdown temperature.

### [Method of Measuring Tensile Strength]

The prepared porous film sample (ASTM D638 Type IV standard) is measured in the condition of 50 mm/min using a universal testing machine in accordance with ASTM D638.

### [Method of Measuring Puncture Strength]

A separator having a thickness of 15 μm is cut into a size of 50×50 mm, and then the sample is placed on a plate with a circular hole having a diameter of 10 mm, and the force at the point when the sample is pierced as lowered at a rate of 0.05 cm/sec using a probe having a diameter of 1 mm (curvature radius of 0.5 mm).

### Advantageous Effects

According to the present invention, in the preparation of polypropylene for a dry separator of a secondary battery, a method for preparing polypropylene for a separator of a secondary battery, which allows both improved flowability during separator processing and maximized mechanical and thermal properties by applying a bimodal process and setting ideal conditions for the input ratio of a co-catalyst and an electron donor.

### BRIEF DESCRIPTION OF THE DRAWINGS

FIG. 1 is an image showing a processing state when a porous film is prepared in Test Example of the present invention.

### MODE FOR CARRYING OUT THE INVENTION

Hereinafter, the present disclosure will be described in detail through preferred embodiments. Before getting to the point, it will be understood that words or terms used in the specification and claims of the present invention shall not be construed as being limited to having the meaning defined in commonly used dictionaries. It will be further understood that the words or terms should be interpreted as having meanings that are consistent with their meanings in the context of the relevant art and the technical idea of the invention, based on the principle that an inventor may properly define the meaning of the words or terms to best explain the invention. Thus, configurations of embodiments described herein are simply the most preferable embodiments of the present disclosure and are not representative of all the technical spirits of the disclosure, and thus it should be understood that there may exist various equivalents and modified examples as substitutes at the time when the present disclosure is filed.

The inventors found that in the preparation of polypropylene for a dry separator of a secondary battery, when the situation requires the development of materials having maximized and mechanical thermal properties, mechanical and thermal properties are maximized at a specific input ratio of a co-catalyst and an electron donor and also flowability is improved during separator processing while a bimodal process is applied.

Accordingly, the present invention discloses a method for preparing polypropylene for a separator of a secondary battery by subjecting, in the presence of a Ziegler-Natta catalyst, propylene monomers to a polymerization reaction, wherein the propylene monomer polymerization reaction includes the steps of: a) obtaining a high molecular weight polypropylene having a weight average molecular weight of 450,000 to 650,000 g/mol in a first reactor; and b) obtaining a low molecular weight polypropylene having a weight average molecular weight of 150,000 to 300,000 g/mol in a second reactor, and the molar ratio of a co-catalyst and an electron donor added in step a) is adjusted to 2 to 25, thereby preparing the polypropylene for a separator of a secondary battery.

In the present invention, the Ziegler-Natta catalyst is a solid catalyst prepared, for example, by making a magnesium compound react with an alkane diol having a carbon number of 3 to 15 unsubstituted or substituted with an alkyl group having a carbon number of 1 to 5, and a benzoyl halide compound to prepare a magnesium compound solution, making the magnesium compound solution react with a transition metal compound to prepare a support, and making the support react with a transition metal compound, and regarding the specific preparation method, Korean Patent No. 1711261 in the name of the applicant is cited as a reference.

In the preparation of polypropylene for a secondary battery separator according to the present invention, a bimodal process is applied while propylene monomers are polymerized in the presence of the solid catalyst. That is, the propylene monomer polymerization reaction includes the steps of: a) obtaining a high molecular weight polypropylene having a weight average molecular weight of 450,000 to 650,000 g/mol in a first reactor; and b) obtaining a low molecular weight polypropylene having a weight average molecular weight of 150,000 to 300,000 g/mol in a second reactor, and thus allows a high crystalline polypropylene to be obtained.

In the present invention, the propylene polymerization reaction may be performed in gas phase, liquid phase, or solution phase. When the polymerization reaction is performed in the liquid phase, a hydrocarbon solvent may be used, and the propylene itself may be used as a solvent. The polymerization reaction temperature may be 0 to 200° C., preferably 50 to 150° C. When the reaction temperature is less than 0° C., the catalyst may have decreased activity, and when the reaction temperature is greater than 200° C., stereoregularity may decrease. Pressure conditions upon polymerization may be 1 to 100 atmospheres, preferably 2 to 30 atmospheres. When the pressure is greater than 100 atmospheres, it is undesirable from an industrial and economic perspective. The polymerization reaction may be performed through any method of a batch type, a semi-continuous type, and a continuous type, and in the present invention, through a continuous bimodal process, a high molecular weight polypropylene having a weight average molecular weight of 450,000 to 650,000 g/mol in the first reactor, and a low molecular weight polypropylene having a weight average molecular weight of 150,000 to 300,000 g/mol in the second reactor may be mixed at a weight ratio of 8:2 to 4:6, preferably, a high molecular weight polypropylene having a weight average molecular weight of 500,000 to 600,000 g/mol in the first reactor and a low molecular weight polypropylene having a weight average molecular weight of 180,000 to 240,000 g/mol in the second react may be mixed at a weight ratio of 7:3 to 5:5 to prepare a final polypropylene having a weight average molecular weight of 300,000 to 500,000 g/mol and a molecular weight distribution (Mw/Mn) of 6 to 10, preferably a weight average molecular weight of 350,000 to 450,000 g/mol and a molecular weight distribution (Mw/Mn) of 6.5 to 8, more preferably a molecular weight distribution (Mw/Mn) of 6.5 to 7. That is, low molecular weight and high molecular weight polypropylenes are evenly included, and accordingly, flowability may be improved during separator processing while the maximized mechanical and thermal properties of polypropylene are maintained by applying a specific co-catalyst/electron donor input ratio, which will be described later.

In this case, a co-catalyst and an external electron donor are introduced into the first reactor to reduce the transition metal compound in the solid catalyst, thereby removing a portion of an internal electron donor present in the solid catalyst, and the external electron donor is bonded to this vacant site to allow the polymerization reaction to proceed, and in the present invention, it is determined that the mechanical and thermal properties of polypropylene prepared through the bimodal process were dramatically improved when the ratio of the electron donor to an input co-catalyst was applied at a lower level than a typical level.

That is, in the present invention, the molar ratio of the co-catalyst and the electron donor added in step a) may be 2 to 25, preferably 3 to 16, more preferably 4 to 6.

The co-catalyst and the electron donor are not particularly limited as long as they are components used in the preparation of polypropylene for typical secondary battery dry separators, for example, as the co-catalyst, trimethyl aluminum, triethyl aluminum, triisobutyl aluminum, trioctyl aluminum, and the like may be used, as the electron donor, cyclohexylmethyldimethoxysilane, dicyclopentyldimethoxysilane, diisopropyldimethoxysilane, vinyltriethoxysilane, triethylmethoxysilane, trimethylethoxysilane, dicyclopentyldiethoxysilane, ethyltrimethoxysilane, ethyltriethoxysilane, diphenyldiethoxysilane, phenylpropyldimethoxysilane, phenyltrimethoxysilane, tertiary butyltrimethoxysilane, cyclohexylethyldimethoxysilane, cyclohexylmethyldimethoxysilane, cyclopentyltriethoxysilane, diisobutyldiethoxysilane, isobutyltriethoxysilane, normalpropyltrimethoxysilane, isopropyltrimethoxysilane, cycloheptylmethyldiethoxysilane, dicycloheptyldiethoxysilane, and the like may be used, and preferably, triethyl aluminum (TEAL) may be used as the co-catalyst, and dicyclopentyldimethoxysilane may be used as the electron donor.

In general, general-purpose polypropylene has a crystallinity of about 50 to 52%, but the polypropylene prepared according to the present invention is a high crystalline polypropylene having a crystallinity of 55% or greater. In addition, the polypropylene prepared according to the present invention has a very high stereoregularity of 97% or greater, and thus has a melting temperature of 167° C. or greater, a high crystallization temperature, and excellent mechanical and thermal properties.

Antioxidants, neutralizers, nucleating agents, and the like may be further added to the polymerized polypropylene during a kneading process, and a porous film may be prepared in a dry manner by stretching an extruded sheet. The method used to prepare a separator using a dry method with respect to the polypropylene described above may be a method in which a polymer crystal portion is oriented in a predetermined direction, and then a relatively weak amorphous portion is ruptured through cold stretching to form pores. In addition, the separator may be prepared through differences in polymer crystal shape and crystallization temperature, and when prepared through the way described above, a nucleating agent is added. Accordingly, it is believed that the characteristics of a microporous membrane to be prepared are determined by the degree of orientation of the polymer crystal portion and the polymer crystal shape, and also by additives and modifiers to be added.

For example, in the present invention, the separator may be prepared by extruding the polypropylene using a twin-screw extruder at a temperature of 200 to 230° C. through a T-die method to form a sheet, and simultaneously and sequentially stretching the sheet in MD and TD directions in a stretching machine to form a porous film. In order to be used as a separator for secondary batteries, the film is required to have a porosity of at least 30%, and mechanical properties such as puncture strength and tensile strength are critical factors that determine the usability thereof. As seen in Examples below, the polypropylene for a separator of a secondary battery according to the present invention improves the thermal properties and flowability (processability) along with the mechanical properties of the film used as a secondary battery separator material, and has an improved meltdown temperature.

Specifically, the polypropylene for a separator of a secondary battery according to the present invention may have a meltdown temperature of 166° C. or greater, preferably 168° C. or greater, a xylene soluble of 3 wt % or less, preferably 1.5 wt % or less, more preferably 1.2 wt % or less, a tensile strength of 1,300 kgf/cm² or greater, preferably 1,400 kgf/cm² or greater, and a puncture strength of 220 gf or greater, preferably 230 gf or greater, measured according to methods below.

Hereinafter, the present invention will be described in more detail through specific Examples and Comparative Examples.

### Example 1

A 2 L pressure-resistant glass reactor equipped with a stirrer and an oil circulation heater was sufficiently ventilated with nitrogen, anhydrous magnesium dichloride, 2,4-pentanediol, and decane were added in a nitrogen atmosphere and stirred at 130° C. at a rotation speed of 500 rpm. A magnesium compound was completely dissolved to produce a homogeneous solution, and the solution was aged for 1 hour, and then benzoyl chloride was added for 30 minutes, aged at 130° C. for 1 hour, and the temperature of a reactor was lowered to 25° C. to prepare a magnesium compound solution. Thereafter, the pressure-resistant glass reactor equipped with a stirrer and an oil circulation heater was sufficiently ventilated with nitrogen, 800 L of hexane and 800 L of titanium tetrachloride were added under nitrogen reflux and stirred at 130° C. at a rotation speed of 300 rpm while the temperature of the reactor was lowered to −20° C. to prepare a mixed solvent. The magnesium compound solution prepared above was added to the reactor into which the titanium compound dispersed in the hexane solvent was added for 4 hours. The magnesium compound solution was added and maintained for 1 hour, and then the temperature of the reactor was raised at a rate of 0.25° C./min until the temperature of the reactor reached 20° C. When the temperature of the reactor reached 20° C., the solution was aged for 1 hour, and the temperature of the reactor was raised up to 73° C. at a rate of 1° C./min, and after reaching 73° C., the solution was aged for 2 hours and a supernatant excluding precipitated solids in the reactor was removed to produce a solid support. Thereafter, titanium tetrachloride was added to the prepared solid support, stirred, and heated at a rate of 1° C./min to add 2,2′-diisobutylphthalate and 1,3-diether mixed in a molar ratio of 1:1 at 110° C. Then, the mixture was aged for 1 hour, the solid catalyst was precipitated again, and the supernatant was removed. The solid catalyst from which the supernatant was removed was additionally washed once with titanium tetrachloride, cooled to 63° C., and washed seven times with 1 L of hexane to obtain a final slurry solid catalyst. The final slurry solid catalyst was dried with nitrogen to obtain a solid catalyst for polypropylene polymerization.

The polypropylene polymerization was performed by applying a bimodal process through bulk polymerization using the solid catalyst and propylene as a solvent. First, a 2 L nitrogen atmosphere heated to 120° C. was formed in a first reactor. The temperature of the reactor was lowered to 25° C. in a nitrogen atmosphere and ventilated with propylene to maintain the reactor in a propylene atmosphere. Into the reactor maintained in a propylene gas atmosphere, 2 mmol of triethylaluminum (TEAL) diluted in a decane solvent at a 1 molar concentration was added, and dicyclopentyldimethoxysilane (donor) diluted in a decane solvent was added SO that triethylaluminum and dicyclopentyldimethoxysilane were at a molar ratio of 4.4 to 5. The catalyst was diluted in a decane solvent and added in an amount of 0.005 g, 1,000 ml of hydrogen was added, 500 g of propylene was added, and the mixture was subjected to prepolymerization for 5 minutes using a stirrer. After the prepolymerization, the temperature of the reactor was heated to 70° C. and polymerization was performed at 70° C. for 1 hour, and then unreacted propylene was discharged to the atmosphere and the temperature of the reactor was lowered to room temperature to obtain a high molecular weight polypropylene having a weight average molecular weight of about 550,000 g/mol and a relatively low melt index. In a second reactor, the same method as above is performed, but the polymerization time is adjusted to obtain a low molecular weight polypropylene having a weight average molecular weight of about 210,000 g/mol and a relatively low melt index, and the obtained high molecular weight polypropylene and low molecular weight polypropylene were polymerized at a weight ratio of about 6:4. The resulting polypropylene was dried in a vacuum oven at 50° C. for 10 hours and obtained.

### Example 2, Comparative Examples 1 to 3

Polypropylene was prepared in the same manner as in Example 1, except that the polymerization process and TEAL/Donor ratio in Example 1 were adjusted as shown in Table 1 below. A monomodal process was performed using only the first reactor to be provided with the median average molecular weight shown in Table 1 below.

### Test Example

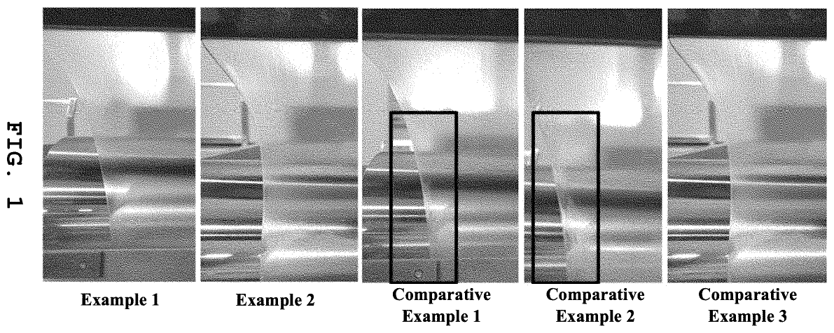

The prepared polypropylene was extruded using a twin-screw extruder at 220 to 250° C. through a T-die method to form a sheet, and then the sheet was sequentially stretched in MD and TD directions in a stretching machine to form a single-layer porous film having a thickness of 15 μm, and the polypropylene and film were measured and evaluated for molecular weight properties, meltdown temperature, xylene soluble, tensile strength, puncture strength, and flowability through the following methods, and the results are shown in Table 1 and FIG. 1 below.

### [Measurement Methods]

### (1) Molecular Weight Properties

Weight average molecular weight and molecular weight distribution (Mw/Mn) were measured using gel permeation chromatography (GPC) (Agilent) in accordance with ASTM D3536, Polystyrene was used as a standard material in the presence of a chloroform solvent.

### (2) Meltdown Temperature

A lithium-ion secondary battery manufactured using the prepared porous film was heated in an oven at a rate of 2° C./min to measure resistance in real time so as to evaluate the temperature at the point of exceeding 10,000Ω as a shutdown temperature, and the temperature at the point of rapidly decreasing resistance after the above shutdown temperature as a meltdown temperature. The term ‘shutdown’ refers to properties of closing pores due to partial melting on a film above a specific temperature, and although a short circuit in which a positive electrode and a negative electrode of secondary batteries are directly connected due to thermal deformation of the film at high temperatures is the main cause of explosions and fire accidents, the short circuit may be prevented through the shutdown. In this case, the term ‘meltdown’ (or ‘rupture’) refers to a phenomenon in which a film is partially damaged due to melting on the film above a specific temperature, and when the phenomenon occurs, an accident such as fire or explosion may take place due to a short circuit in which a positive electrode and a negative electrode of secondary batteries are bonded.

### (3) Xylene Soluble

In accordance with ASTM D5492, a sample was dissolved in boiling xylene, and then an insoluble portion was crystallized from the solution, and a soluble portion was separated and measured,

### (4) Tensile Strength

A porous film sample (ASTM D638 Type IV standard) was measured in the condition of 50 mm/min using a universal testing machine in accordance with ASTM D638, and

### (5) Puncture Strength

A separator having a thickness of 15 μm was cut into a size of 50×50 mm, and then the sample was placed on a plate with a circular hole having a diameter of 10 mm, and the force at the point when the sample was pierced as lowered at a rate of 0.05 cm/sec using a probe having a diameter of 1 mm (curvature radius of 0.5 mm) was measured.

### (6) Flowability

The prepared polypropylene was extruded using a twin-screw extruder at 220° C. through a T-die method, and the extruded product was subjected to passed through T-die, and then the presence or absence of melt fractures and extrudate defects were determined in the extruded product.

TABLE 1

| | | | | Comparative | Comparative | Comparative |
|---|---|---|---|---|---|---|
| Item | Unit | Example 1 | Example 2 | Example 1 | Example 2 | Example 3 |
| Polymerization | — | Bimodal | Bimodal | Monomodal | Monomodal | Bimodal |
| process | | | | | | |
| Teal/Donor | — | 4.4~5.0 | 14.9~15.3 | 4.9~5.2 | 14.9~15.3 | 32.7~33.1 |
| ratio | | | | | | |
| Xylene soluble | wt % | 1.1 | 1.7 | 1.3 | 1.6 | 4.1 |
| Meltdown | ° C. | 168 | 166 | 168 | 166 | 163 |
| temperature | | | | | | |
| Tensile | kgf/ | 1,500 | 1,400 | 1,450 | 1,430 | 1,260 |
| strength of | cm² | | | | | |
| separator | | | | | | |
| Thickness of | μm | 15 | 15 | 15 | 15 | 15 |
| separator | | | | | | |
| Puncture | gf | 240 | 230 | 235 | 235 | 210 |
| strength of | | | | | | |
| separator | | | | | | |
| Weight average | g/mol | 420,000 | 393,000 | 395,000 | 394,000 | 362,000 |
| molecular | | | | | | |
| weight | | | | | | |
| Molecular | — | 6.8 | 6.0 | 4.6 | 4.5 | 5.9 |
| weight | | | | | | |
| distribution | | | | | | |

Referring to Table 1 and FIG. 1, in the preparation of polypropylene for a dry separator of a secondary battery, it is seen that when a bimodal process and a specific co-catalyst and electron donor input ratio were applied according to the present invention, mechanical and thermal properties were maximized and also flowability was improved when separator processing, compared to typical ones.

In this context, it is seen that when polypropylene was prepared through a monomodal process (Comparative Examples 1 and 2), molecular weight distribution was narrow and thus resin flowability was degraded, causing defects such as melt fractures in the extruded product (see black box in FIG. 1), indicating poor processability, and even in the case in which polypropylene was prepared through a bimodal process, when the TEAL/Donor input ratio was the same as typical methods (Comparative Example 3), degraded thermal properties, such as reduced meltdown temperature, and degraded mechanical properties are shown.

The preferred embodiments of the present disclosure have been described. The descriptions of the present disclosure are only illustrative, and those skilled in the art to which the present disclosure pertains may appreciate that other specific modifications can be easily made without changing the technical idea or essential features thereof.

Thus, the scope of the present disclosure is defined by the appended claims rather than the detailed description, and it will be understood that the present disclosure should be construed to cover all modifications or variations induced from the meaning and scope of the appended claims and their equivalents.

1. A method for preparing polypropylene for a separator of a secondary battery by subjecting, in the presence of a Ziegler-Natta catalyst, propylene monomers to a polymerization reaction,
wherein the propylene monomer polymerization reaction comprises the steps of: a) obtaining a high molecular weight polypropylene having a weight average molecular weight of 450,000 to 650,000 g/mol in a first reactor; and b) obtaining a low molecular weight polypropylene having a weight average molecular weight of 150,000 to 300,000 g/mol in a second reactor, and
the molar ratio of a co-catalyst and an electron donor added in step a) is adjusted to 2 to 25, thereby preparing the polypropylene for a separator of a secondary battery.

2. The method of claim 1, wherein the co-catalyst is at least one selected from the group consisting of trimethyl aluminum, triethyl aluminum, triisobutyl aluminum, and trioctyl aluminum, and the electron donor is at least one selected from the consisting of group cyclohexylmethyldimethoxysilane, dicyclopentyldimethoxysilane, diisopropyldimethoxysilane, vinyltriethoxysilane, triethylmethoxysilane, trimethylethoxysilane, dicyclopentyldiethoxysilane, ethyltrimethoxysilane, ethyltriethoxysilane, diphenyldiethoxysilane, phenylpropyldimethoxysilane, phenyltrimethoxysilane, tertiary butyltrimethoxysilane, cyclohexylethyldimethoxysilane, cyclohexylmethyldimethoxysilane, cyclopentyltriethoxysilane, diisobutyldiethoxysilane, isobutyltriethoxysilane, normalpropyltrimethoxysilane, isopropyltrimethoxysilane, cycloheptylmethyldiethoxysilane, and dicycloheptyldiethoxysilane.

3. The method of claim 1, wherein the polypropylene for a separator of a secondary battery has a weight average molecular weight of 300,000 to 500,000 g/mol, a molecular weight distribution (Mw/Mn) of 6 or greater, a meltdown temperature of 166° C. or greater, a xylene soluble of 3 wt % or less, a tensile strength of 1,300 kgf/cm² or greater, and a puncture strength of 220 gf or greater, measured according to methods below:
[Method of Measuring Molecular Weight Properties]
weight average molecular weight and molecular weight distribution (Mw/Mn) are measured using gel permeation chromatography (GPC) (Agilent) in accordance with ASTM D3536,
[Method of Measuring Xylene Soluble]
a sample is dissolved in boiling xylene, and then an insoluble portion is crystallized from the solution and a soluble portion is separated and measured in accordance with ASTM D5492,
[Method of Measuring Meltdown Temperature]
the polypropylene for a separator is extruded using a twin-screw extruder at 220 to 250° C. through a T-die method to form a sheet, and then the sheet was sequentially stretched in MD and TD directions in a stretching machine to prepare a single-layer porous film having a thickness of 15 μm, and a lithium-ion secondary battery manufactured using the prepared porous film is heated in an oven at a rate of 2° C./min to measure resistance in real time so as to evaluate the temperature at the point of exceeding 10,000Ω Q as a shutdown temperature, and the temperature at the point of rapidly decreasing resistance after the above shutdown temperature as a meltdown temperature,
[Method of Measuring Tensile Strength]
the prepared porous film sample (ASTM D638 Type IV standard) is measured in the condition of 50 mm/min using a universal testing machine in accordance with ASTM D638, and
[Method of Measuring Puncture Strength]
a separator having a thickness of 15 μm is cut into a size of 50×50 mm, and then the sample is placed on a plate with a circular hole having a diameter of 10 mm, and the force at the point when the sample is pierced as lowered at a rate of 0.05 cm/sec using a probe having a diameter of 1 mm (curvature radius of 0.5 mm) is measured.
